(19) United States
(12) Patent Application Publication
(10) Pub. No.: US 2023/0192565 A1
(43) Pub. Date: Jun. 22, 2023

(54) ACTIVATION SYSTEM, INCLUDING AT LEAST ONE ALKALINE METAL SALT AND CALCIUM AND/OR MAGNESIUM CARBONATE FOR ACTIVATING GROUND GRANULATED BLAST FURNACE SLAG AND BINDER COMPRISING THE SAME FOR THE PREPARATION OF MORTAR OR CONCRETE COMPOSITION

(71) Applicants: ECOCEM MATERIALS LIMITED, DUBLIN (IE); INSTITUT NATIONAL DES SCIENCES APPLIQUEES DE TOULOUSE, TOULOUSE CEDEX 4 (FR); ECOCEM FRANCE, Aix -en-Provence (FR)

(72) Inventors: Bernard SALESSES, PARIS (FR); Martin CYR, TOULOUSE CEDEX 4 (FR); Roberta ALFANI, PARIS (FR); Nicolas MUSIKAS, PARIS (FR); Laurent FROUIN, PARIS (FR)

(21) Appl. No.: 17/917,032

(22) PCT Filed: Apr. 8, 2020
(86) PCT No.: PCT/EP2020/060084

§ 371 Date: Oct. 5, 2022

(51) Int. Cl. C04B 40/00; C04B 28/08; C04B 22/12; C04B 22/14; C04B 14/28

(52) U.S. Cl. CPC C04B 40/0039; C04B 14/28; C04B 22/124; C04B 22/147; C04B 28/08; C04B 2111/00646

(57) ABSTRACT

An activating composition, in particular for concrete or industrial mortars containing hydraulic binder and/or pozzolanic material, comprises at least 40% by weight, preferably at least 50% by weight of calcium carbonate and/or magnesium carbonate particles having a d80 less than or equal to 15 µm, and a d50 less than or equal to 4 µm, and at least 1.5% by weight and up to 60% by weight of at least one alkaline metal salt. A binder composition is also provided, the binder composition comprising the activating composition and a component C comprising at least one hydraulic binder. The binder composition and at least one aggregate are combined to form a dry concrete or industrial mortar composition. Also provided is a process for preparing wet concrete or mortar compositions and hardened concrete or industrial mortar compositions obtained therefrom.

### FIELD OF THE INVENTION

The technical field of the invention relates to hydraulic mineral binders including at least one slag, for instance a Ground Granulated Blast furnace Slag (GGBS or slag), which are used in compositions able to set and harden, such as mortar or concrete compositions.

More particularly, the invention relates to binders and compositions able to set and harden for the building industry, which include at least one slag as hydraulic binder as well as at least one activation system.

The invention concerns also the methods of preparation of these slag-based binders, of these dry or wet compositions able to set and harden.

The building applications made of the set and hardened products obtained from these compositions are also in the field of the invention.

### BACKGROUND ART

Portland cement production has a strong and negative impact on the environment due to the emissions of large quantities of carbon dioxide. The production of cement inherently generates CO₂ during the calcination of the raw materials at very high temperature (1450° C.) in a kiln through decarbonation of the limestone (Eq. (1)):

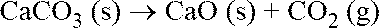

In addition, carbon dioxide is released as a result of the combustion of the fossil fuels needed to heat the cement kiln. By adding the additional emissions of grinding, almost one ton of CO₂ per ton of Portland cement is obtained. Overall, the cement industry is responsible for about 7 to 9% of the global carbon dioxide emissions.

Moreover, handling Portland cement may lead to health issues (such as allergy) due in particular to its high alkalinity (pH higher than 13). In addition, hazardous elements as hexavalent Chromium (Cr (VI)) may be released upon kneading, which is also unhealthy for the workers when it gets in contact with the skin. Although Cr (VI) reducing agents (as ferrous sulfate) are normally included in the cement powder, their efficiency is limited in time. Building workers, in particular those in the third world, are not expected to often check the deadline related to such treatments.

Most current research on new binders aims to replace cement in various applications by binders with lower environmental impact. One route is through using resources without their expensive treatment, such as by-products from other industries (waste for one industry, but primary resource for others). This is the case of blast-furnace slag which is a by-product of iron industry. By grinding this product into fine powder (GGBS) one can obtain a cementitious material that can be used in partial substitution of cement or used alone by adding some chemical activators.

It is important to note that the use of a GGBS is not only environmentally-friendly but also leads to several enhanced properties when it’s used to formulate mortars and concretes, such as high resistance to sulfate attack, low permeability, good resistance in a chemically aggressive environment, low heat of hydration (required in massive structures), excellent durability in general, possibility of immobilization of heavy metals or radionuclides, etc.

It should be emphasized that GGBS is a hydraulic binder (in contrast with fly-ash or silica fume for example that are latent hydraulic binders). This means that GGBS alone reacts with water. Addition of a chemical activator (and/or heating) is advantageous to speed up this reaction and to improve early ages strengths. Generally, the role of the activator is to increase pH to an appropriate level in order to enhance nucleophilic attack of the glass network by the hydroxyl ions.

The activator promotes the setting and/or the curing and/or the hardening of the binder, the mortar/concrete composition.

So as to activate the GGBS, activation systems have been developed. For instance, international patent application WO 2017/198930 discloses a binder comprising GGBS and an accelerator. This accelerator comprises one source of calcium sulfate and one nucleating agent in the form of particle.

Although this accelerator allows obtaining construction materials containing at least 80% by weight of GGBS, there is still a need to develop activation systems for materials containing GGBS, in particular at low temperature and for obtaining hardened concretes or industrial mortars having better mechanical properties, especially at early age, than hardened concretes and industrial mortars comprising only ordinary Portland cement as binder.

In this context, the invention aims at addressing at least one of the above problems and/or needs, through fulfilling at least one of the following objectives:
-O1- Providing a slag-based binder or a mortar or concrete composition including said slag-based binder, which is attractive substitute to Ordinary Portland Cement (OPC)-based compositions.
-O2- Providing a slag-based binder or a mortar or concrete composition including said slag -based binder, which is environmentally friendly.
-O3- Providing a slag-based binder or a mortar or concrete composition including said slag-based binder, which is more acceptable than OPC-based compositions, with respect to the health and safety issues.
-O4- Providing a slag based binder or a mortar or concrete composition including said slag based binder, which gives rise to dry-mortars, dry and semi-dry precast concrete and wet mortars and concrete formulations with appropriate ability to be manufactured by several ways, like vibro-compaction, spraying, trowelling, casting, etc.
-O5- Providing a slag-based binder or a mortar or concrete composition including said slag-based binder, which gives rise to wet formulations with appropriate rheological properties, i.e stable rheology (good workability) during the usual setting time (e.g. from some minutes to several hours) required by the users of said wet formulation.
-O6- Providing a slag-based binder or a mortar or concrete composition including said slag-based binder, which gives rise to a hardened material with required mechanical properties, especially an acceptable early strength (for instance 24 hours).
-O7- Providing a slag-based binder or a mortar or concrete composition including said slag-based binder, which gives rise to a hardened material with required durability.
-O8- Providing a slag-based binder or a mortar or concrete composition including said GGBS-based binder, which gives rise to a hardened material with the usually required setting time (e.g. from some minutes to several hours).
-O9- Providing a simple and cheap method of preparation of the slag-based binder or the mortar or concrete composition including said slag-based binder, which complies with at least one of the objectives -O1- to -O9-.
-O10- Providing a simple and cheap method of preparation of a wet form of the slag-based binder or a mortar or concrete composition including said slag-based binder.
-O11- Providing hardened products for the building industry including slag as at least partial binder.

### ADVANTAGES OF THE INVENTION

One of the advantages of the invention is to improve the construction materials including GGBS, especially a dry-mortar or a concrete composition which gives rise to a hardened material with required mechanical properties, especially an acceptable early strength (for instance 24 hours) and long terms performances as well.

Another advantage is the possibility, in an embodiment of the invention, to use the binder composition according to the invention at low temperatures, i.e. around 5° C.

An additional advantage is the universality of the activation composition which could be included in very various concretes or industrial mortars which require very different quantity of water, in particular, the activation composition according to the invention could be part of compositions with high water content.

### SUMMARY OF THE INVENTION

The invention concerns an activating in particular for concrete or industrial mortars containing hydraulic binder and/or pozzolanic material comprising:
A. at least 40% by weight, preferably at least 50% by weight of calcium carbonate and/or magnesium carbonate particles having a d80 less than or equal to 15 µm, and a d50 less than or equal to 4 µm, and
B. at least 1.5% by weight and up to 60% by weight of at least one alkaline metal salt.

The invention also concerns a binder composition comprising the activating composition according to any one of claims 1 and 2, and a component C consisting in at least one hydraulic binder.

Without being bound by any theory, it is believed that the content and the particle size of the calcium carbonate and/or magnesium carbonate included in the activating composition according to the present invention fill the empty spaces of the mortar/concrete in which the activating composition is intended to be added and it can contribute to water retention in the product. These two phenomena, coupled with alkaline activation due to the presence of the alkaline metal salt, may enhance the early hydration of said hydraulic binder and improve the mechanical strength of the resulting concrete or industrial mortar by a better distribution of hydrated phases.

The invention is further directed to dry concrete or industrial mortar compositions comprising at least one aggregate and said binder composition.

The invention is further directed to dry concrete or industrial mortar compositions comprising other components, like admixtures and said binder composition.

In addition, the invention relates to a process for preparing wet concrete or mortar compositions and to hardened concrete or industrial mortar compositions obtained therefrom.

### DEFINITIONS

According to the terminology of this text, the following non limitative definitions have to be taken into consideration:
“slag” denotes a stony by-product matter separated from metals during the smelting or refining of ore.
“GGBS” or “GGBFS”: Ground Granulated Blast Furnace Slag, which is equivalent to blast furnace slag, Granulated Blast Furnace Slag (GBFS), blast furnace water-crushed slag powder and blast furnace slag fine aggregate.
“cement” is understood as meaning a powdery substance made for use in making mortar or concrete. It is a mineral binder, possibly free from any organic compound. It refers to any ordinary cement and it includes slag Portland blended and alkali-activated based cements.
“binder” refers to “hydraulic binder” meaning any material that hardens just by adding water, like GGBS and cement.
“supplementary cementitious material” refers to a material which contributes to the strength of a binder through latent hydraulic or pozzolanic activity. Here the term refers, fly ash, activated clay, silica fume, basic oxygen furnace slag, natural pozzolanic materials, rice husk ash, activated recycled concrete fine aggregates or a mixture thereof.
“mortar” refers to a material composed of binder(s), aggregates such as sand and other components, like admixtures.
“concrete” refers to a material composed of binder(s), aggregates such as sand and gravel and other components, like admixtures.
“d50” gives the median size of the granulometric distribution of material’s particles (usually in micrometres for cementation materials). It means that 50% of the particles have a size less than the specified number and 50% of the particles have a size greater than the given number. The measurement of d50 is done by Laser diffraction analysis, also known as Laser diffraction spectroscopy, by means of Laser diffraction analyzer such as “Mastersizer 2000” and commercialized by the MALVERN company, with the humid way method.
“d80” gives information on the granulometric distribution of material’s particles (usually in micrometres for cementation materials). It means that 80% of the particles have a size less than the specified number and 20% of the particles have a size greater than the given number. The measurement of d80 is done by Laser diffraction analysis, also known as Laser diffraction spectroscopy, by means of Laser diffraction analyzer such as “Mastersizer 2000” and commercialized by the MALVERN Company, with the humid way method.

### BRIEF DESCRIPTION OF THE FIGURES

FIGS. 1 to 3 are bar diagrams comparing compressive strengths of different industrial mortars according to the invention and outside the invention.

### DETAILED DESCRIPTION OF THE INVENTION

### The Activating Composition

So as to achieve the objective of accelerating the kinetic of the hardening reaction for GGBS, especially at an early stage, providing concrete or industrial mortar presenting suitable compressive strength at an early stage (24 h) according to the final application, and similar to or better than the compressive strength of industrial mortar or concrete having a binder exclusively made of Portland cement at early stage (7 days) and late stage (28 days). The activating composition of the present invention developed by the inventors, in particular for concrete or industrial mortars containing hydraulic binder and/or pozzolanic material comprises:
A. at least 40% by weight, preferably at least 50% by weight of calcium carbonate and/or magnesium carbonate particles having a d80 less than or equal to 15 µm, and a d50 less than or equal to 4 µm, and
B. at least 1.5% by weight and up to 60% by weight of at least one alkaline metal salt.

In a particular embodiment, the activating composition of the present invention is free of calcium sulfate source.

### A. Calcium/Magnesium Carbonate

According to the present invention, the activating composition comprises at least 40% by weight of calcium carbonate and/or magnesium carbonate. In a preferred embodiment, the activating composition comprises at least 50% by weight of calcium carbonate and/or magnesium carbonate.

According to the present invention, the calcium carbonate and/or magnesium carbonate particles have a d80 less than or equal to 15 µm, preferably less than or equal to 10 µm, and a d50 less than or equal to 4 µm

### B. Alkaline Metal Salt

Depending on the concrete or industrial mortar compositions in which the activating composition of the invention is intended to be ultimately incorporated, the quantity of said alkaline metal salt in the said activating composition is adjusted.

Hence, in one embodiment, for instance for masonry mortars, the activating composition comprises preferably between 1.5% and 15% by weight of said alkaline metal salt, more preferably between 3% and 10% by weight and even more preferably between 4% and 5% by weight.

In another embodiment, for instance for tile adhesives, the activating composition comprises preferably between 25% and 60% by weight of said alkaline metal salt, more preferably between 35% and 55% by weight and even more preferably between 40% and 50% by weight.

The alkaline metal salt is advantageously selected in the group consisting in sodium chloride (NaCl), sodium sulphate (Na₂SO₄), potassium sulphate (K₂SO₄), potassium chloride (KCl), sodium carbonate (Na₂CO₃) and potassium carbonate (K₂CO₃) and mixture thereof.

### Binder Composition

The invention also concerns a binder composition comprising said activating composition, and a component C consisting in at least one hydraulic binder.

In one embodiment, component C consists in exclusively grounded granulated blast furnace.

Grounded granulated blast furnace (GGBS) is a glassy granular material obtained by quenching molten slag from a blast furnace in water, and then by finely grinding the quenched product to improve GGBS reactivity. GGBS is an amorphous aluminosilicate glass, essentially composed of SiO₂, CaO, MgO, and Al₂O₃. A number of glass network cation modifiers are present: Ca, Na, Mn, etc.

GGBS is preferably manufactured according to the European standard [NF EN 15167-1].

As such, the binder composition according to this embodiment of the present invention advantageously comprises between 60% and 99% by weight of grounded granulated blast furnace, advantageously between 70% and 97% by weight.

The binder composition according to this embodiment of the present invention advantageously comprises between 1% and 40% by weight of the activating composition described above, more advantageously between 3% and 30%.ln addition, the binder composition according to this embodiment of the present invention advantageously comprises between more than 0.5% and 10% by weight of alkaline metal salt, advantageously between 0.7% and 7% by weight.

In another embodiment, component C consists in a mixture of grounded granulated blast furnace and at least another hydraulic binder, preferably selected from the group consisting of hydraulic binder according to the standard EN 197-1, and cement based on alumina or calcium aluminate.

In particular, by cement, we refer to any ordinary cement, as described in European Standard EN 197.1, that is a hydraulic binder composed by calcium silicates (3CaO [symbol] SiO2) and (2CaO [symbol] SiO2) and Al2O3, Fe2O3 and other oxides; for example a clinker of Portland cement.

Hydraulic binder according to the present invention includes white and grey cement according to the standard EN 197-1, cementitious agglomerates and hydraulic lime too.

According to the present invention, binder based on calcium sulfoaluminate clinkers, as described in EP-A-1306356 “Clinker sulfoalumineux sans fer et sans chaux libre, son procede de preparation et son utilisation dans des liants blancs” and in “Calcium sulfoaluminates cements-low energy cements, special cements” J.H. Sharp et al., Advances in Cement Research, 1999, 11, n.1, pp. 3-13. can be used too.

Calcium alumina cement according to EN 14647 and sulfoferroaluminate cements can be used as well, as described in Advances in Cement Research, 1999, 11, No. 1, Jan.,15-21.

According to the present invention Supersulfated cement (SSC) as described in EN 15743 and other cement known to be used in severe conditions, like cements according to NF P 15-317 “ciments pour travaux à la mer” (PM) and NF P 15-319 “ciments pour travaux en eaux à haute teneur en sulfates” (ES) can be used too.

According to the invention, the binder composition may comprise one or more supplementary cementitious materials advantageously selected from the group consisting of fly ash, metakaolin, activated clay, silica fume, basic oxygen furnace slag, natural pozzolanic materials, rice husk ash, activated recycled concrete fine aggregates or a mixture thereof. Supplementary cementitious material refers to a material which contributes to the strength of a binder through latent hydraulic or pozzolanic activity.

As such, in the binder composition according to this embodiment of the present invention component C advantageously comprises at least 30% by weight of grounded granulated blast furnace slag, more advantageously between 40% and 90% by weight, and even more advantageously between 50% and 80% by weight.

In addition, the binder composition according to this embodiment of the present invention advantageously comprises between 50% and 99% by weight of component C, advantageously between 60% and 97% by weight.

The binder composition according to this embodiment of the present invention advantageously comprises between 1.5% and 35% by weight of the activating composition described above, more advantageously between 2% and 28%.

Moreover, the binder composition according to this embodiment of the present invention advantageously comprises between more than 0.5% and 5% by weight of alkaline metal salt, advantageously between 0.7% and 3.5% by weight.

### Optional Other Components

The binder composition is advantageously enriched with one or several other components which are ingredients, notably functional additives preferably selected in the following list:
Water retention agent.

A water retention agent has the property to keep the water of mixing before the setting. The water is so trapped in the wet formulation paste which improves its bond. To some extent, the water is less absorbed by the support.

The water retentive agent is preferably chosen in the group comprising: modified celluloses, modified guars, modified cellulose ethers and/or guar ether and their mixes, more preferably consisting of: methylcelluloses, methylhydroxypropylcelluloses, methylhydroxyethyl-celluloses and their mixes.
Rheological agent

The possible rheological agent (also named a “thickener”) is preferably chosen in the group comprising, more preferably consisting in: clays, starch ethers, cellulose ethers and/or gums (e.g. Welan guar xanthane, succinoglycans), modified polysaccharides -preferably among modified starch ethers-, polyvinylic alcohols, polyacrylamides, clays, sepiolites, bentonites, and their mixes, and more preferably chosen in the group of clays, bentonite, montmorillonite.
Water reducing polymer

The water reducing polymer, also named superplasticizers, is selected from the group consisting of lignosulfonate polymers, melamine sulfonate polymers, naphthalene sulfonate polymers, polycarboxylic acid ether polymers, polyoxyethylene phosphonates, vinyl copolymers, and mixtures thereof.
Defoamer/Antifoams

The possible defoamer is preferably chosen in the group comprising, more preferably consisting in: polyether polyols and mixes thereof.
Biocide

The possible biocide is preferably chosen in the group comprising, more preferably consisting in: mineral oxides like zinc oxide and mixes thereof.
Pigment

The possible pigment is preferably chosen in the group comprising, more preferably consisting in: TiO₂, iron oxide and mixes thereof.
Flame retardant

The possible flame retardant (or flame proof agent), which makes it possible to increase the fire resistance and/or to shrink the speed of flame spreading of the composition is preferably chosen in the group comprising, more preferably consisting in:
Air-entraining agents

Air-entraining agents (surfactants) are advantageously chosen in the group, more preferably consisting in natural resins, sulfated or sulfonated compounds, synthetic detergents, organic fatty acids and their mixes, preferably in the group comprising, more preferably consisting in the lignosulfonates, the basic soaps of fatty acids and their mixes, and, more preferably in the group comprising, more preferably consisting in the sulfonate olefins, the sodium lauryl sulfate and their mixes.
Retarders

Retarders are advantageously chosen in the group, more preferably consisting in tartric acid and its salts: sodium or potassium salts, citric acid and its salts: sodium (trisodic citrate) and their mixes.

In addition, other components may be:
Plasticizers
Fibres
Dispersion powders
Wetting agents
Polymeric resins
Complexing agents
Drying shrinkage reducing agents based on polyols.

The total content of these optional other components in the binder composition is preferably comprised between 0.001% and 10% by weight of the total weight of the binder composition.

### Dry Concrete or Industrial Mortar Composition

The invention also relates to dry concrete or industrial mortar composition, in particular tile adhesive, coating, masonry mortars, repair mortars, renders, technical mortars and mortars for floor covering comprising at least one aggregate fraction (sand and/or gravel) the binder composition described above. The dry concrete or industrial mortar composition may eventually contain other admixtures and additions.

According to the invention, “dry” concrete or industrial mortar composition refers to composition that are in the form of powder and ready to be mixed with water. In other words, the dry concrete or industrial mortar composition of the invention may content some moisture, but it essentially contains solid component which are intended to be mixed with water before its application.

In a preferred embodiment, the activating composition represents between 0.1% by weight and 5% by weight of the total dry composition, including binder, filler, sand, gravel and other components, preferably between 0.25 and 3.5% by weight.

This embodiment is advantageous since it enables to reach early strengths at low temperature too, of about 5° C., of concrete and industrial mortar including the activating composition according to the present invention.

In other words, the dry concrete or industrial mortar composition comprises the binder composition, according to the invention as herein defined and at least one aggregate, notably: sands and/or gravels, and/or fillers at different particle size distributions.

Aggregates comprise a large category of particulate material used in construction, including sands, gravels, crushed stones, slag (not-granulated), recycled concrete and geosynthetic aggregates. They serve as reinforcement to add strength to the overall composite material.

The dry concrete or industrial mortar composition can also include fillers, for example based on quartz, limestone, clays and mixtures thereof as well as light fillers, such as perlites, diatomaceous earth, expanded mica (vermiculite) and foamed sand, and mixtures thereof.

Advantageously, said dry concrete or industrial mortar composition can also include, apart from aggregates, one or several ingredients, especially functional admixtures, additions and fibres, which can be the same as the other optional component mentioned above defined in the detailed description of the binder composition.

The total content of these optional other components in the dry concrete or industrial mortar composition is preferably comprised between 0.1% and 10% by weight of the total weight of the binder composition.

### Wet Concrete or Industrial Mortar Composition

The invention also refers to a wet concrete or industrial mortar composition in particular tile adhesive, coating, assembling mortars, repair mortars, renders, technical mortars and mortars for floor covering comprising at least one aggregate and the binder composition described above.

In a specific embodiment, wet mortar compositions are so called “Ready to use” mortars. “Ready to use” mortars are used for assembling bricks or blocks on building site. They are obtained by mixing all the elements of the composition (binder, aggregates and others components) with water directly at the mixing plant. They include a set retarding agent, allowing transport and delayed use up to several days, while maintaining its rheological and hardening properties.

### Process for Preparing Wet Concrete or Mortar Composition

The invention also relates to a process for preparing the wet concrete or industrial mortar composition described above comprising a step of mixing the at least one aggregate and the binder composition with water, the binder composition being prepared before the mixing step or in situ during the mixing step.

In other words, wet concrete or industrial mortar composition could be prepared by two distinct methods.

In a first method, the activating composition, then the binder composition are prepared, alternatively, the binder composition is directly prepared by mixing components A, B and C. After that the dry concrete or industrial mortar composition is finally obtained by mixing the at least one aggregate and the binder composition. The dry concrete or mortar composition is thereafter mixed with water.

In a second method, the wet concrete or industrial mortar composition is prepared by mixing in water each component of each composition directly without preparing said compositions separately in advance.

According to the present disclosure, the term “mixing” has to be understood as any form of mixing.

In a preferred embodiment a part of the binder and at least a part of the water are mixed together prior to the mixing with the aggregate.

In a preferred embodiment, the process is implemented with water to binder composition ratio comprised between 0.2 and 2, advantageously between 0.3 and 1.8.

### Hardened Concrete or Industrial Mortar Composition

The present invention also refers to hardened concrete or industrial mortar composition obtained from the concrete or industrial mortar composition described above.

### EXAMPLES

### Example 1: Tile Adhesive

A dry tile adhesive composition comprising as a binder ordinary Portland cement (OPC) (CE1) and a dry tile adhesive composition comprising as a binder a mixture of Portland cement and Ground Granulated Blast furnace Slag (GGBS) (E1) have been prepared. The content of each dry tile adhesive composition is set forth in table 1 below.

TABLE 1

| Example (Tile adhesives) | CE1 (counter-example) | E1 (invention) |
|---|---|---|
| Activating composition | | |
| Calcium carbonate (wt%) | N/A | 75 |
| Sodium chloride (wt%) | | 25 |
| Binder composition | | |
| Activating composition (wt%) | 0 | 2.78 |
| GGBS (wt%) | 0 | 72.91 |
| OPC (wt%) | 100 | 24.31 |
| Binder composition (wt%) | 35.5 | 36 |
| Calcium formate (wt%) | 0.5 | 0 |
| Sand (wt%) | 51.1 | 51.1 |
| Limestone filler (wt%) | 10 | 10 |
| Cellulose ether (wt%) | 0.4 | 0.4 |
| Latex (wt%) | 2.5 | 2.5 |
| Water/dry powder ratio (wt%) | 26 | 25 |

Each dry tile adhesive composition has been mixed with the amount of water as in table 1 leading to the same initial mortar’s viscosity (measured by Brooksfield equipment), 530 Pa*s ±10. Both water amounts correspond to a weight ratio water to binder (i.e. OPC and eventually GGBS) of 0.7 so as to obtained wet tile adhesive compositions. Tile adhesive formulations have been characterized according to Standard EN 12004- “Adhesives for ceramic tiles” results are set forth in table 2 below.

TABLE 2

| | | | | | | |
|---|---|---|---|---|---|---|
| Example | 1 day | 28 days | T20 min | T30 min | 28 days under water | 28 days under heat |
| CE1 | 0.8 MPa | 1 MPa | 0.6 MPa | 0.2 MPa | 1.1 MPa | 1.1 MPa |
| E1 | 0.25 MPa | 1.2 MPa | 1.4 MPa | 0.8 MPa | 1.5 MPa | 1.3 MPa |
| Target values for C2E tile adhesives According to standard EN 12004 | – | 1 MPa | 0.5 MPa | 0.5 MPa | 1 MPa | 1 MPa |

It can be seen from table 2 that except after 1 day, the tile adhesive of the invention (E1) has greater resistance than the tile adhesive CE1. In addition, the tile adhesive of the invention (E1) has resistance higher than the required standards for C2E tile adhesives.

### Example 2: Masonry Mortar

A dry masonry mortar composition comprising as a binder ordinary Portland cement (OPC) (CE2) and a dry masonry mortar composition comprising as a binder a mixture of Portland cement and Ground Granulated Blast furnace Slag (GGBS) (E2) have been prepared. The content of each dry masonry mortar composition is set forth in table 3 below.

TABLE 3

| Example (Masonry mortars) | CE2 (counter-example) | E2 (invention) |
|---|---|---|
| Sand (wt%) | 87.75 | 84.62 |
| OPC (wt%) | 12.2 | 7.9 |
| GGBS (wt%) | 0 | 4.3 |
| Cellulose ether (wt%) | 0.03 | 0.03 |
| Air entraining agent (wt%) | 0.02 | 0.02 |
| Calcium carbonate (wt%) | 0 | 3 |
| Sodium sulfate (wt%) | 0 | 0.065 |
| Sodium chloride (wt%) | 0 | 0.065 |

Therefore, the masonry mortar according to the invention (E2) contains 15.33 wt% of the binder composition according to the invention, which itself comprises 20.42 wt% of the activating composition according to the invention.

As a result, each dry masonry mortar contains 12.2% by weight of hydraulic binder, either only OPC (CE2) either OPC and GGBS (E2).

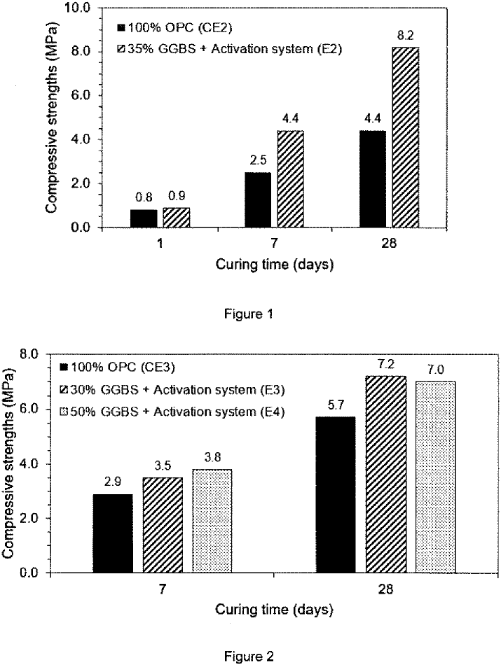

Each dry masonry mortar composition has been mixed with a water amount of 14% wt% corresponding to a weight ratio water to binder (i.e. OPC and eventually GGBS) of 1.1 so as to obtained wet masonry mortar compositions. The compressive strengths have been measured at after different times; the measurements are set forth in FIG. 1.

It can be seen from FIG. 1 that the compressive strength of masonry mortar E2, according to the invention, is higher than the compressive mortar of CE2 after 1 day, 7 days and 28 days.

### Example 3: Render

A dry render composition comprising as a binder ordinary Portland cement (OPC) (CE3) and two dry render compositions comprising as a binder a mixture of Portland cement and Ground Granulated Blast furnace Slag (GGBS) (E3 and E4) have been prepared. The content of each dry render composition is set forth in table 4 below.

TABLE 4

| Example (Renders) | CE3 (counter-example) | E3 (invention) | E4 (invention) |
|---|---|---|---|
| Sand (wt%) | 76.8 | 76.8 | 76.8 |
| OPC (wt%) | 10.9 | 7.63 | 5.45 |
| GGBS (wt%) | | 3.27 | 5.45 |
| Limestone filler (wt%) | 12 | 8.9 | 8.9 |
| Cellulose ether (wt%) | 0.1 | 0.1 | 0.1 |
| Air entraining agent (wt%) | 0.1 | 0.1 | 0.1 |
| Sodium oleate | 0.1 | 0.1 | 0.1 |
| Calcium carbonate (wt%) | 0 | 3 | 3 |
| Sodium sulfate (wt%) | 0 | 0.05 | 0.05 |
| Sodium chloride (wt%) | 0 | 0.05 | 0.05 |

Therefore, both renders compositions of examples E3 and E4 according to the invention contain 15.33 14 wt% of the binder composition according to the invention, which itself comprises 22.14 wt% of the activating composition according to the invention.

As a result, each dry render contains 10.9% by weight of hydraulic binder, either only OPC (CE3) either OPC and GGBS (E3 and E4).

Each dry render composition has been mixed with a water amount of 20% wt% corresponding to a weight ratio water to binder (i.e. OPC and eventually GGBS) of 1.8 so as to obtained wet render compositions. The compressive strengths have been measured after different times; the measurements are set forth in FIG. 2.

It can be seen from FIG. 2 that the compressive strength of renders E3 and 34, according to the invention, is lower than the compressive strength of render CE3 after 1 day. However, the compressive strengths of renders E3 and E4 are enough for renders application.

Nonetheless, after 7 days and 28 days the compressive strength of renders E3 and E4, according to the invention, are higher than the compressive strength of render CE3.

### Example 4: Low Temperature Hardening

A dry mortar composition comprising as a binder ordinary Portland cement (OPC) (CE4) and two dry mortar compositions comprising as a binder a mixture of Portland cement and Ground Granulated Blast furnace Slag (GGBS) (CE5 and E5) have been prepared. The content of each dry mortar composition is set forth in table 5 below.

TABLE 5

| Example | CE4 (counter-example) | CE5 (counter-example) | E5 (invention) |
|---|---|---|---|
| Sand (wt%) | 75 | 75 | 70 |
| OPC (wt%) | 25 | 12.5 | 12.5 |
| GGBS (wt%) | 0 | 12.5 | 12.5 |
| Calcium carbonate (wt%) | 0 | 0 | 4.75 |
| Sodium sulfate (wt%) | 0 | 0 | 0.125 |
| Sodium chloride (wt%) | 0 | 0 | 0.125 |

Therefore, the mortar according to the invention (E5) contains 30 wt% of the binder composition according to the invention, which itself comprises 16.66 wt% of the activating composition according to the invention.

As a result, each dry mortar contains 25% by weight of hydraulic binder, either only OPC (CE4) either OPC and GGBS (CE5 and E5).

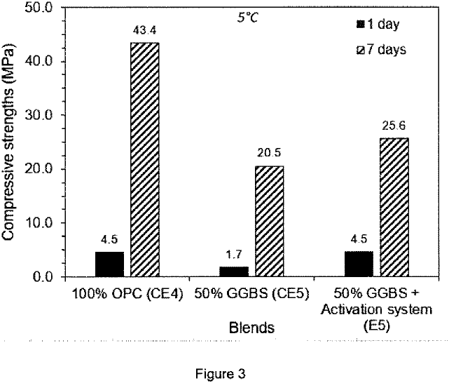

Each dry mortar composition has been mixed with water with a weight ratio water to binder (i.e. OPC and eventually GGBS) of 0.5 so as to obtained wet mortar compositions cured at a temperature of 5° C. The compressive strengths have been measured after different times; the measurements are set forth in FIG. 3.

It can be seen from FIG. 3 that the compressive strength of mortar E5, according to the invention, is equal to the compressive strength of mortar CE4 (100% OPC) after 1 day and higher than the one of mortar CE5 (GGBS+OPC without the activating composition of the invention) after 1 day and after 7 days.

1. An Activating composition, in particular for concrete or industrial mortars containing hydraulic binder and/or pozzolanic material comprising:
A. at least 40% by weight, of calcium carbonate and/or magnesium carbonate particles having a d80 less than or equal to 15 µm, and a d50 less than or equal to 4 µm, and
B. at least 1.5% by weight and up to 60% by weight of at least one alkaline metal salt.

2. The activating composition according to claim 1, wherein it comprises between 1.5% and 15% by weight of said alkaline metal salt .

3. The activating composition according to claim 1, wherein it comprises between 25% and 60% by weight of said alkaline metal salt .

4. The activating composition according to claim 1 , wherein the alkaline metal salt is selected in the group consisting of sodium chloride (NaCl), sodium sulphate (Na₂SO₄), potassium sulphate (K₂SO₄), potassium chloride (KCl), sodium carbonate (Na₂CO₃) and potassium carbonate (K₂CO₃) and mixtures thereof.

5. A binder composition comprising the activating composition according to claim 1 , and a component C consisting in at least one hydraulic binder.

6. The binder composition according to claim 5, wherein component C consists in exclusively grounded granulated blast furnace.

7. The binder composition according to claim 5, wherein component C consists in a mixture of grounded granulated blast furnace and at least another hydraulic binder, selected from the group consisting of hydraulic binders according to the standard EN 197-1, and cement based on alumina or calcium aluminate and mixtures thereof.

8. The binder composition according to claim 6, wherein it comprises between 60% and 99 % by weight of grounded granulated blast furnace .

9. The binder composition according to claim 6 , wherein it comprises between 1% and 40% by weight of the activating composition .

10. The binder composition according to claim 6 , wherein it comprises between more than 0.5% and 10% by weight of alkaline metal salt .

11. The binder composition according to claim 7, wherein component C comprises at least 30% by weight of grounded granulated blast furnace slag .

12. The binder composition according to claim 7 , wherein it comprises between 50% and 99% by weight of component C .

13. The binder composition according to claim 7 , wherein it comprises between 1.5% and 35% by weight of the activating composition .

14. The binder composition according to claim 7 , wherein it comprises between more than 0.5% and 5% by weight of alkaline metal salt .

15. A dry concrete or a dry industrial mortar composition, in particular tile adhesive, coating, assembling mortars, repair mortars, renders, technical mortars and mortars for floor covering comprising at least one aggregate and the binder composition according to claim 5 .

16. A wet concrete or a wet industrial mortar composition in particular tile adhesive, coating, assembling mortars, repair mortars, renders, technical mortars and mortars for floor covering comprising at least one aggregate and the binder composition according to claim 5 and water.

17. A process for preparing the wet concrete or the wet industrial mortar composition of claim 16 comprising a step of mixing with water, at least one aggregate, and the binder composition, the binder composition being prepared before the mixing step or in situ during the mixing step from at least some of the different components of the binder composition taken separately and/or under the form of premix(es).

18. The process according to claim 17, wherein the ratio water to binder composition is comprised between 0.2 and 2, advantageously between 0.3 and 1.8.

19. A hardened concrete or a hardened industrial mortar composition obtained from the wet concrete or the wet industrial mortar composition according to claim 16.
